(19) United States
(12) Patent Application Publication
(10) Pub. No.: US 2015/0161568 A1
(43) Pub. Date: Jun. 11, 2015

(54) PERFORMANCE PROFILE SYSTEM

(71) Applicant: Brian Edward BODKIN, Chester, NJ (US)

(72) Inventor: Brian Edward BODKIN, Chester, NJ (US)

(21) Appl. No.: 14/560,692

(22) Filed: Dec. 4, 2014

Related U.S. Application Data
(60) Provisional application No. 61/912,083, filed on Dec. 5, 2013.

(51) Int. Cl. G06Q 10/10

(52) U.S. Cl. CPC G06Q 10/1053

(57) ABSTRACT

A performance profile system is provided. The performance profile system may embody a method for creating a performance profile by surveying relevant performance references. The performance profile system may include receiving at least one performance category of the job-seeker, wherein each performance category is associated with at least one performance competency question. The performance profile system may prompt the job-seeker to identify at least one reference associated with the performance categories selected, wherein the job-seeker provides referential information associated with each reference. The performance profile system may then generate a referral questionnaire comprising the at least one performance competency question for each selected performance category and then transmit the referral questionnaire to the at least one reference using at least in part the referential information. After receiving a response from at least one reference part to the referral questionnaire, the performance profile system may create an accessible report incorporating at least the performance competency questions, the responses and other details of the job-seeker.

### CROSS-REFERENCE TO RELATED APPLICATION

This application claims the benefit of priority of U.S. provisional application No. 61/912,083, filed 5 Dec. 2013, the contents of which are herein incorporated by reference.

### BACKGROUND OF THE INVENTION

The present invention relates to background investigations and, more particularly, to a system for generating a performance profile; for example, a employment background report for prospective employers.

Currently, there are millions of job-seekers in the United State trying to stand out from the pack. The traditional method is for an applicant to submit their resume to a prospective employer, and for the latter to decide to spend the resources to pursue the applicant based mostly on comparing the applicant's resume with a vast number of other resumes. Assuming the applicant passes this initial hurdle, the employer needs to dig deeper either on their own, through their human resources department and/or by contracting a recruiter to do a further investigation of validating the claims found in their resume.

Moreover, a resume rarely reveals what previous supervisors or peers thought of the applicant's work product, and it is rarer still to have such information corroborated on the resume. As a result, many prospective employers have to incur the time and cost of doing a background check to only find out that much of the information on a resume was misleading, false or otherwise incapable of being externally confirmed at the time of the investigation.

As can be seen, there is a need for a system for generating a reference-based performance profile, whereby in the job market an applicant can use the resulting employment history background check to set themselves apart from other job-seekers as well as attract prospective employers with the opportunity of saving time, money and effort in doing their traditional investigation.

### SUMMARY OF THE INVENTION

In one aspect of the present invention, a system for generating a referenced performance profile comprises: a computer having a user interface, wherein the computer is electronically connected to at least one database; and a program product comprising machine-readable program code for causing, when executed, the computer to perform the following process steps: producing an electronic representation of a plurality performance categories on the user interface, wherein each performance category is associated with at least one performance competency question stored in the at least one database; prompting a user to select at least on performance category from the plurality of performance categories via the user interface; prompting a user to identify at least one reference for the at least one selected performance category, wherein the user provides referential information associated with each reference; receiving the referential information from the user; generating a referral questionnaire comprising the at least one performance competency question for each selected performance category; transmitting the referral questionnaire to the at least one reference using at least in part the referential information; and receiving a response from at least one reference in regards at least in part to the referral questionnaire.

In another aspect of the present invention, an automated method for providing a performance profile for a job-seeker comprises: receiving at least one performance category of the job-seeker, wherein each performance category is associated with at least one performance competency question; identifying at least one reference of the at least one performance category selected by the job-seeker, wherein the job-seeker provides referential information associated with each reference; generating a referral questionnaire comprising the at least one performance competency question for each selected performance category; transmitting the referral questionnaire to the at least one reference using at least in part the referential information; and receiving a response from at least one reference in regards at least in part to the referral questionnaire.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a schematic view of an exemplary embodiment of the present invention and a continuation of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a performance profile system embodying a method for creating a performance profile by surveying individual references who can provide first-hand verification of the performance in question. The performance profile system may include receiving at least one performance category of the job-seeker, wherein each performance category is associated with at least one performance competency question. The performance profile system may prompt the job-seeker to identify at least one reference associated with the performance categories selected, wherein the job-seeker provides referential information associated with each reference. The performance profile system may then generate a referral questionnaire comprising the at least one performance competency question for each selected performance category and then transmit the referral questionnaire to the at least one reference using at least in part the referential information. After receiving a response from at least one reference part to the referral questionnaire, the performance profile system may create an accessible report incorporating at least the performance competency questions, the responses and other details of the job-seeker.

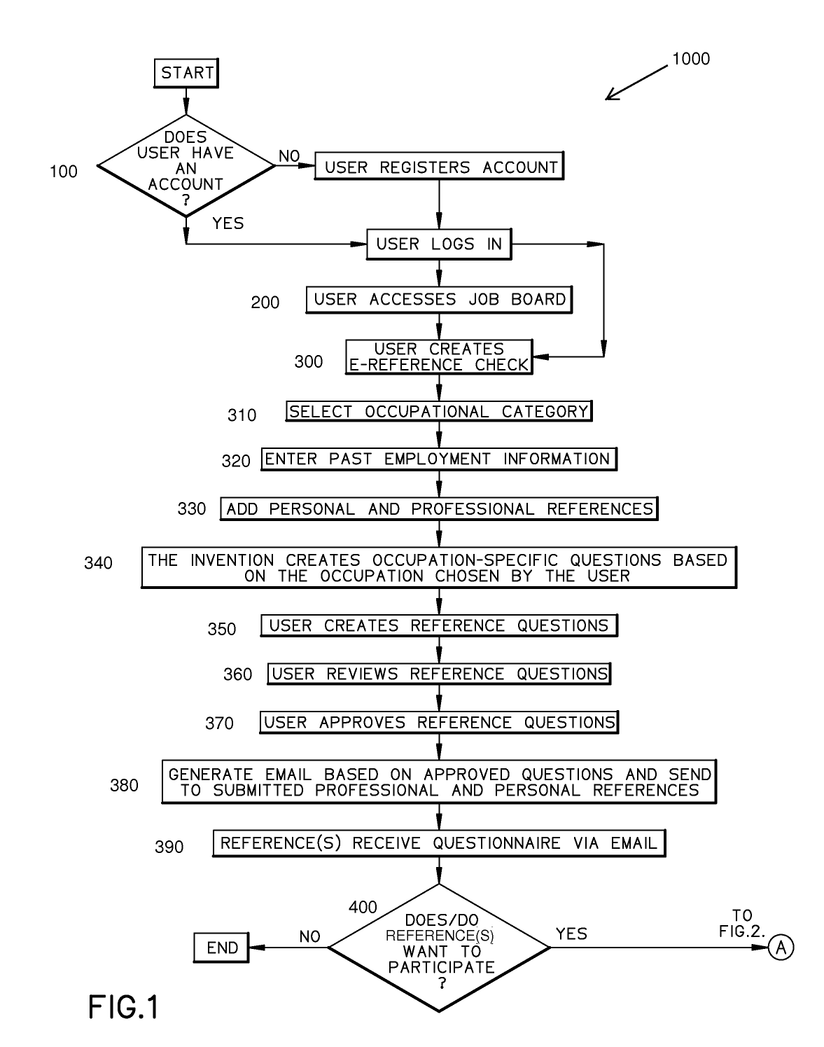

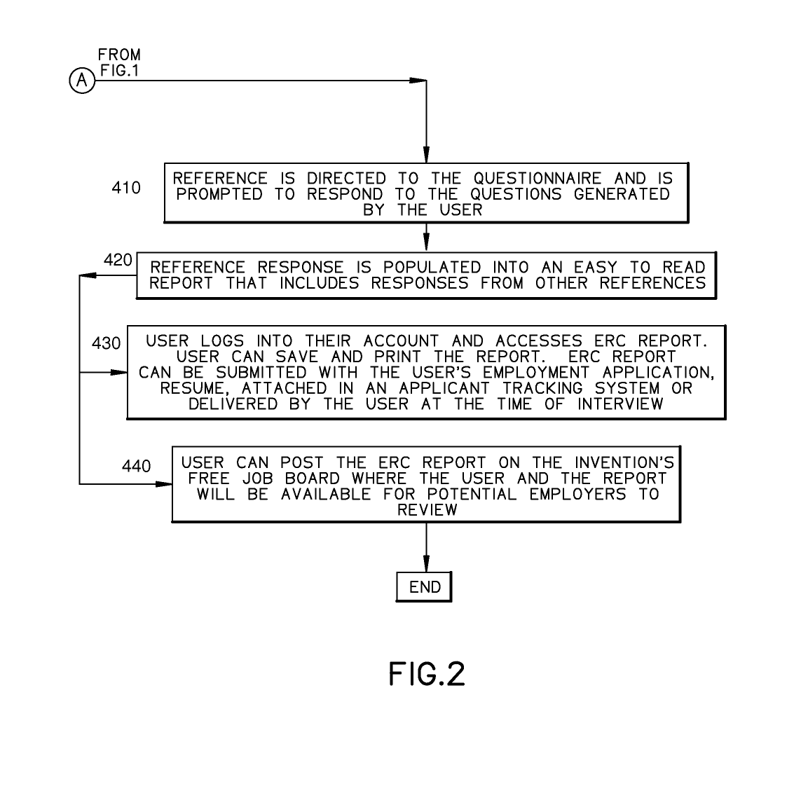

Referring to FIGS. 1 and 2, the present invention may include a performance profile system 1000 embodying a method for use in creating a performance profile by surveying relevant performance references. The performance profile system 1000 may include at least one computer with a user interface. The computer may include at least one processing unit electronically coupled to a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device.

The software may be accessed by the computer using a web browser. The computer may access the software via the web browser using the internet, extranet, intranet, host server, internet cloud and the like.

The software provides access for a user to a plurality of databases. At least one database may be an automated reference check system (or ARCS). The ARCS may prompt a user for and store information such as a user's first and last name and email address, a user's permission settings and associated data, a user's account information such as login, password, and any password retrieval verification information, and additional member profile information. ARCS may initiate a user authentication and account creation process according to an embodiment of the present invention.

In step 100, the account creation process provides access through the user interface to unauthenticated users interested in creating a user account. Upon successful completion of the user account, the user may then attempt to login and if successful, the user gains access to a user portal. The user portal may provide navigation options wherein the user may select among several navigation options by selecting, for example, a “My Account” tab to facilitate a user account management process, a “Upload a Resume” tab to allow the user to attach and upload to the ARCS user account performance documents/files of various types, such as examples of work product, resumes, etc., and a “Create Your ERC Report” tab to enter a performance profile portal wherein the user may create a performance profile by surveying relevant performance references, in step 300.

In certain embodiments, in step 200, the “Create Your ERC Report” feature may be accessed directly through a job board as disclosed in more detail later herein.

After the “Create Your ERC Report” tab has been selected, in step 310, the performance profile portal may prompt the user to identify performance categories relevant to their desired performance profile. In some embodiments, the performance profile portal may provide a menu of relevant occupations for the user interested in an employment-related profile to select from. The performance profile portal may provide relevant performance categories based in part on the data ARCS extracts from the performance documents uploaded to the associated user account and/or past employment information the performance profile portal prompts the user for, in step 320.

In step 380, the performance profile portal allows the user to begin the process of creating a referral questionnaire based in part on the selection of relevant performance categories and an associated group of references, as explained in more detail below.

Based on the selection of relevant performance categories, the performance profile portal may generate a plurality of performance category-specific competency questions stored in at least one of the plurality of databases, in step 340. For example, if the user is interested in an employment-related profile and so selects performance categories related to occupations, the plurality of occupation-specific competency questions may include but not be limited to work experience, job duties, questions regarding the general performance, abilities, reliability and/or competency of the user and/or specific job requirements, such as degree of technical knowledge, etc. In certain embodiments, the performance category-specific competency questions may include or be replaced by a predetermined number of general competency questions that aim to represent the particular characteristics the user demonstrates when performing general task, function or projects. In steps 350 through 370, the performance profile portal may provide convenient menu options for reviewing and deleting at least one performance category-specific competency question and/or adding user-tailored reference questions. The user-tailored reference questions may represent the particular characteristics the user demonstrates when performing performance category-specific tasks, functions and/or projects. The performance profile portal may generate the referral questionnaire populated by the selected, non-deleted plurality of performance category-specific competency questions, the user-tailored reference questions and the referential information.

In step 330, the performance profile portal may prompt the user to create a new group of references to which the referral questionnaire is to be directed.

The group of references may comprise referential information including but not be limited to each reference's name, company affiliation, company roles, company's relation to selected performance categories, dates the user was affiliated with the company of reference and reference title, contact information, email addresses and social networking information. The group of references may include professional and personal references who may offer insight into and be able to answer at least a portion of the referral questionnaire. The ARCS may associate each group of references and their associated referral questionnaire with a user account.

The performance profile portal may provide the user an option to e-mail the referral questionnaire to the associated group of references identified by the user by way of the email addresses provided in the referential information so that each reference receives said referral questionnaire, in step 390. The performance profile portal may enable email address verification procedures.

The performance profile portal, through the resulting e-mail by way of dynamic link or the like, may provide a questionnaire interface whereby each reference may be presented a representative of the associated referral questionnaire, in step 410. In some embodiments, each reference may be queried by the questionnaire interface as to whether they want to participate in answering at least a part of the associated referral questionnaire, in step 400. Such query may be conditioned on terms of service or the like. Within the questionnaire interface each identified reference may be presented with the populated competency questions and any user-tailored reference questions. Within such questionnaire interface, each identified reference may enter information about the user associated with the referral questionnaire, including both qualitative and quantitative information about the user. Here, each reference may also evaluate, answer and otherwise respond to the represented referral questionnaire on a rating scale, in narrative form or the like. The questionnaire interface may allow each reference to indicate a general level of competency possessed by the user as well as review and comment on the referential information included in the referral questionnaire. In certain embodiments, each reference may have the option to answer some but not the entirety of the questionnaire when they evaluate, answer, confirm, rate or deny the questions therein.

The performance profile portal may associate a unique identifier to each referral questionnaire, wherein the unique identifier is stored in the associated user account so that the user or a third party having the unique identifier may access a pre-existing referral questionnaire and modify and or reuse said questionnaire for subsequent performance profiling purposes.

The questionnaire interface provides means for each reference to transmit their responses to the performance profile portal. In certain embodiments, the original reference email may provide a return button so that each reference may click the return button and the responses to the referral questionnaire may be returned to the associated user account by way of the performance profile portal.

For each referral questionnaire, the performance profile portal may compile the responses of the associated group of references and use the results to populate an ERC Report, in step 420. The performance profile portal may prompt each user to email the ERC Report to prospective employers, post the ERC Report with or without the performance documents/resume on resume posting sites, and otherwise include the ERC Report in response to job openings in order that their submission stands out to prospective employers, in step 430.

The performance profile portal may associate a unique access code to each ERC Report, wherein the access code may be stored in the user account so that the user or a third party having the unique identifier may access a pre-existing

ERC Report. The performance profile system 1000 may provide access to prospective employers and/or recruiters to user accounts so as to review performance documents and associated ERC Report pursuant to the terms and conditions, whereby the performance profile system 1000 offers, in effect, a job board in step 440. The user may send an access code to prospective employers and/or recruiters to remotely access the ERC Report through the ARCS. Through such job board, registered job-seekers with pre-made, easy to read ERC Reports for prospective employers and/or recruiters are available to fill identified positions.

In certain embodiments, prospective students who need references and referrals as part of a scholastic application process may use the performance profile system 1000. Similarly, in certain embodiments, candidates for internship programs and special education programs could use the job-seeker driven process 200.

The performance profile system 1000 may include a third party background investigation process further including a client account in at least one of the plurality of databases that can access the performance profile system 1000, the ARCS and/or said job board. The client account may provide a menu of occupations for the third party user to identify relevant job openings, duties, responsibilities and the like they are interested in filling with at least one potential applicant from the plurality of users of the ARCS. The client account may generate an email to the plurality of potential applicants that substantially match the relevant job openings, duties, responsibilities earlier-identified by the third party user. The client account may send a client referral questionnaire to the plurality of references of all substantially-matching potential applicants. For example, the client account may be used by Human Resources to elicit responses from references listed by the plurality of potential applicants for employment associated with ARCS, the job board and/or the performance profile system 1000.

In certain embodiments, the performance profile system 1000 may be used by businesses to conduct performance-related surveys of their customers. The service could be used as references to obtain new business, evaluate current practices and determine the level of customer satisfaction. In certain embodiments, business uses may include evaluating current employees, independent contractors, temporary employees and vendors.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for generating a referenced performance profile, comprising:
a computer having a user interface, wherein the computer is electronically connected to at least one database; and
a program product comprising machine-readable program code for causing, when executed, the computer to perform the following process steps:
producing an electronic representation of a plurality performance categories on the user interface, wherein each performance category is associated with at least one performance competency question stored in the at least one database;
prompting a user to select at least on performance category from the plurality of performance categories via the user interface;
prompting a user to identify at least one reference for the at least one selected performance category, wherein the user provides referential information associated with each reference;
receiving the referential information from the user;
generating a referral questionnaire comprising the at least one associated performance competency question for each selected performance category;
transmitting the referral questionnaire to the at least one reference using at least in part the referential information; and
receiving at least one response from at least one reference in regards to the transmitted referral questionnaire.

2. The system of claim 1, further providing generating an ERC report comprised of at least in part the received at least one response.

3. The system of claim 1, further providing generating menu options for the user to review and delete the at least one performance competency question.

4. The system of claim 3, wherein the generated menu options enables the user to add user-tailored reference questions to the at least one performance competency question.

5. The system of claim 2, further providing associating each ERC report with a unique identifier.

6. The system of claim 5, further providing transmitting the ERC report to third parties submitting the associated unique identifier,
whereby organizing a job board for employers to find suitable job-seekers having pre-made employment background checks.

7. The system of claim 4, wherein the transmitted referral questionnaire provides a questionnaire interface configured to enable the at least one reference to provide at least one of qualitative information, quantitative information, and comment on the at least one performance competency question.

8. The system of claim 7, wherein the transmission of the referral questionnaire to the at least one reference is configured to query whether each reference wants to participate in providing at least one of qualitative information, quantitative information, and comment on the at least one performance competency question.

9. The system of claim 1, wherein the referential information comprises a verifiable email address of each reference.

10. The system of claim 1, wherein the at least one performance competency question stored in the at least one database comprises a predetermined number of general competency questions.

11. An automated method for providing a performance profile for a job-seeker comprising:
receiving at least one performance category of the job-seeker, wherein each performance category is associated with at least one performance competency question;
identifying at least one reference of the at least one performance category selected by the job-seeker, wherein the job-seeker provides referential information associated with each reference;
generating a referral questionnaire comprising the at least one associated performance competency question for each selected performance category;
transmitting the referral questionnaire to the at least one reference using at least in part the referential information; and
receiving at least one response from at least one reference in regards at least in part to the transmitted referral questionnaire.

12. The method of claim 11, further providing generating an ERC report comprised of at least in part the received at least one response.

13. The method of claim 11, further providing generating menu options for the user to review and delete the at least one performance competency question.

14. The method of claim 13, wherein the generated menu options enables the user to add user-tailored reference questions to the at least one performance competency question.

15. The method of claim 12, further providing associating each ERC report with a unique identifier.

16. The method of claim 15, further providing transmitting the ERC report to third parties submitting the associated unique identifier,
whereby organizing a job board for employers to find suitable job-seekers having pre-made employment background checks.

17. The method of claim 14, wherein the transmitted referral questionnaire provides a questionnaire interface configured to enable the at least one reference to provide at least one of qualitative information, quantitative information, and comment on the at least one performance competency question.

18. The method of claim 17, wherein the transmission of the referral questionnaire to the at least one reference is configured to query whether each reference wants to participate in providing at least one of qualitative information, quantitative information, and comment on the at least one performance competency question.

19. The method of claim 11, wherein the referential information comprises a verifiable email address of each reference.

20. The method of claim 11, wherein the at least one performance competency question stored in the at least one database comprises a predetermined number of general competency questions.
